(19) United States
(12) Patent Application Publication
(10) Pub. No.: US 2012/0175556 A1
(43) Pub. Date: Jul. 12, 2012

(54) Open-Cell Foams Having Superabsorbers

(75) Inventor: Peter Rudolf, Ladenburg (DE)

(73) Assignee: BASF SE, Ludwigshafen (DE)

(21) Appl. No.: 13/394,724

(22) PCT Filed: Sep. 7, 2010
(86) PCT No.: PCT/EP2010/063094

§ 371 Date: Mar. 7, 2012

(30) Foreign Application Priority Data
Sep. 18, 2009 (EP) 09170642.4

(51) Int. Cl. B01J 20/28

(52) U.S. Cl. 252/194

(57) ABSTRACT

The invention relates to superabsorbent-endowed open-cell foams in the form of sheet materials comprising an open-cell foam and superabsorbent which are not more than 30 mm in thickness. It further relates to processes for their production and also to their use for moisture regulation.

The present invention relates to open-cell foams endowed with superabsorbents, processes for their production, and also their use for moisture regulation.

Superabsorbents are known. Other common terms for such materials are “high-swellability polymer”, “hydrogel” (often even used for the dry form), “hydrogel-forming polymer”, “water-absorbing polymer”, “absorbent gel-forming material”, “swellable resin”, “water-absorbing resin” and the like. Superabsorbents comprise crosslinked hydrophilic polymers, in particular polymers of (co)polymerized hydrophilic monomers, graft (co)polymers of one or more hydrophilic monomers on a suitable grafting base, crosslinked ethers of cellulose or of starch, crosslinked carboxymethylcellulose, partially crosslinked polyalkylene oxide or natural products swellable in aqueous fluids, examples being guar derivatives, although water-absorbing polymers based on partially neutralized acrylic acid are most common. The essential property of superabsorbents is their ability to absorb and retain amounts of aqueous fluids equivalent to many times their own weight, even under moderate pressure. As the dry superabsorbent takes up liquid, it turns into a gel, a hydrogel in the usual cases of the absorption of water. Their crosslinking distinguishes synthetic superabsorbents in an essential and important way from customary pure thickeners, since the crosslinking renders the polymers insoluble in water. Soluble substances would have no utility as superabsorbents. By far the most important field of use of superabsorbents is to absorb bodily fluids. Superabsorbents are used for example in diapers for infants, incontinence products for adults or feminine hygiene products. Other fields of use include for example those as a water-retaining agent in market gardening, as a water store for protection against fire, for fluid absorption in food packaging or, very generally, for absorption of moisture. The superabsorbent is part of the nonwoven in superabsorbent nonwovens in that the superabsorbent is for example formed on the nonwoven by polymerization of an appropriate monomer solution or suspension applied to the nonwoven, or is incorporated into the nonwoven as a ready-formed pulverulent or fibrous superabsorbent in the course of the production of the nonwoven.

The state of the art of superabsorbents is summarized for example in the monograph “Modern Superabsorbent Polymer Technology”, F. L. Buchholz and A. T. Graham, Wiley-VCH, 1998, pages 69 to 117.

WO 01/56 625 A2, EP 1 178 149 A1 and U.S. Pat. No. 5,962,068 describe processes for producing water-absorbing composites wherein water-absorbing polymers are polymerized on to a fibrous backing or substrate material, especially on to nonwovens. According to WO 02/094 328 A2, the nonwovens are provided with superabsorbent on both sides. WO 2006/106096 A1 describes moisture-regulating composites comprising at least one sheetlike backing or substrate material, at least one water-soluble hygroscopic substance and at least one water-absorbing polymer polymerized onto the backing or substrate material in the presence of the water-soluble hygroscopic substance. JP-A 05-105705 concerns nondeliquescent driers consisting of a backing or substrate material and hygroscopic salts wherein the hygroscopic salts are fixed to the backing or substrate material by means of water-absorbing polymers.

WO 2007/023085 A1 teaches moisture-regulating composites which do not form any undesirable unevennesses on contact with relatively large amounts of liquid (for example when liquid is spilt onto the composite). The moisture-regulating composites of WO 2007/023086 A1 comprise a plasticizer in order that undesirable stiffness may be avoided.

WO 00/64 311 A1 discloses composites wherein superabsorbents were polymerized on to a backing or substrate material. The backing or substrate material is a nonwoven or an open-cell plastics foam, in this case preferably a polyurethane foam. The composites are used for moisture regulation in seat padding. WO 2004/067826 A1 teaches multilayered textile sheet materials, in particular those comprising one-sidedly stitchbonded nonwovens, which may comprise active components such as superabsorbents for example and are suitable as a padding or cushioning material. DE 40 01 207 A1, DE 40 34 920 A1, DE 41 27 337 A1, DE 42 06 895 A1, DE 197 26 810 C1 and DE 198 09 156 A1 relate to the use of moisture-regulating composites in seat furniture, in particular in motor vehicle seats.

WO 2009/106 496 A1 and WO 2009/106 501 A1 teach multilayered composite materials comprising a sheet material and a superabsorbent. The sheet material is a foil, a foam or preferably a textile sheet material, especially a woven or nonwoven fabric. Especially when the sheet material is a textile sheet material, the superabsorbent may be polymerized on to the sheet material. DE 103 49 060 A1 describes water-absorbing structures based on hydrophilic latex foams. One of the disclosed processes for producing such structures is the polymerization of superabsorbents on to the latex foam.

In the highly developed prior art notwithstanding, there continues to be a need for sheetlike materials capable of regulating moisture. They shall more particularly be pervious to moisture, able to store and release moisture, flexible and thin and also useful as constituent part of composites.

There have accordingly been found sheet materials comprising an open-cell foam and a superabsorbent and being not more than 30 mm in thickness. A process for their production and also uses for these sheet materials have also been found.

The sheet materials of the present invention are generally not more than 30 mm in thickness. They are preferably not more than 15 mm in thickness and more preferably not more than 5 mm in thickness. Minimum thickness is solely determined by the needed mechanical stability of the foam and is chosen accordingly. What is generally sufficient is a thickness of at least 0.5 mm, preferably at least 1 mm.

Sheet materials are concerned in the present invention. The meaning which is assigned to sheet materials in connection with this invention is the usual one of a shaped article which has distinctly less extent in one of three dimensions of a cartesian system of coordinates than in the other two dimensions. “Thickness” in connection with this invention is to be understood as meaning that of these dimensions in which the sheet material has the least extent. Put simply, sheet materials are longer and wider than they are thick. Examples of typical sheet materials in the context of this invention are lengths of foam sheeting, as traded in the form of reel product or as cut-to-size pieces, and also offcuts thereof.

An open-cell foam is the basis for the sheet material of the present invention. Any foam is suitable in principle. Polyurethane foams, polyester foams, synthetic or natural latex foams are preferred. Foams of this type and their methods of making are known. These foams are also common commercial products in the form of the reel product or cut-to-size.

The density of a foam that is suitable in the context of this invention is generally at least 10 kg/m³, preferably at least 15 kg/m³ and more preferably at least 20 kg/cm³ and also generally at most 150 kg/m³, preferably at most 120 kg/m³ and more preferably at most 100 kg/m³.

The sheet material of the present invention comprises superabsorbent on the foam used as backing or substrate material. This superabsorbent is produced for example by polymerizing an appropriate monomeric solution or suspension applied to the foam, or is applied to the foam as a ready-made pulverulent or fibrous superabsorbent in the course of the production of the foam. Any known superabsorbent can be used for this.

A comparatively simple process for producing the sheet materials of the present invention comprises the steps of: i) providing a foam, ii) applying to the foam a mixture comprising at least one ethylenically unsaturated monomer bearing at least one acid group, and iii) polymerizing the mixture to form the superabsorbent. The polymerization of a monomer mixture applied to the foam will typically lead to particularly firmly adhering and uniformly distributed particles of superabsorbent, it is also technically comparatively simple and therefore the preferred process for producing sheet materials which are in accordance with the present invention.

The monomer solution or suspension applied to the prepared foam (for example by spraying or by impregnating) for subsequent polymerization in this process typically comprises:

a) at least one ethylenically unsaturated monomer bearing at least one acid group and optionally at least partially neutralized;

b) at least one crosslinker;

c) at least one initiator;

d) optionally one or more ethylenically unsaturated monomers copolymerizable with the monomers recited under a);

e) optionally one or more water-soluble polymers;

f) at least one solvent; and

g) optionally further additions and/or auxiliary materials.

The monomers a) are preferably water-soluble; i.e., the solubility in water at 23° C. is typically at least 1 g/100 g of water, preferably at least 5 g/100 g of water, more preferably at least 25 g/100 g of water and most preferably at least 35 g/100 g of water.

Suitable monomers a) are for example ethylenically unsaturated carboxylic acids, such as acrylic acid, methacrylic acid and itaconic acid. Acrylic acid and methacrylic acid are particularly preferred monomers. Acrylic acid is very particularly preferred.

Further suitable monomers a) are for example ethylenically unsaturated sulfonic acids, such as styrenesulfonic acid and 2-acrylamido-2-methylpropanesulfonic acid (AMPS).

Impurities can have an appreciable effect on the polymerization. Therefore, the raw materials used should be very pure. It is therefore often advantageous to specially purify the monomers a). Suitable methods of purification are described for example in WO 2002/055469 A1, WO 2003/078378 A1 and WO 2004/035514 A1. A suitable monomer a) is for example an acrylic acid purified as described in WO 2004/035514 A1 and comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of the total amount of the monomers a) which is attributable to acrylic acid and/or salts thereof is preferably at least 50 mol %, more preferably at least 90 mol % and most preferably at least 95 mol %.

Monomer a) is typically partly neutralized. True, it is theoretically possible to polymerize the monomer in the nonneutralized state and subsequently to neutralize the resulting polymeric gel, but in the case of structures such as the sheet materials according to the invention an adequately homogeneous neutralization at that stage is usually costly and inconvenient and therefore uneconomical. Preferably, therefore, the monomer is partly neutralized. This is typically accomplished by admixing the neutralization agent as an aqueous solution, or else preferably as a solid, into the monomer or the monomer solution. The degree of neutralization of the monomer is usually at least 25 mol %, preferably at least 50 mol % and more preferably at least 60 mol % and also generally at most 95 mol %, preferably at most 80 mol % and more preferably at most 75 mol %. Customary neutralizing agents can be used, preference being given to alkali metal hydroxides, alkali metal oxides, alkali metal carbonates or alkali metal bicarbonates and also mixtures thereof. Ammonium salts can be used instead of alkali metal salts. Sodium and potassium are particularly preferred as alkali metals, but very particular preference is given to sodium hydroxide, sodium carbonate or sodium bicarbonate and also mixtures thereof.

The monomer solution is stabilized against premature polymerization with preferably up to 250 weight ppm, more preferably at most 130 weight ppm, even more preferably at most 70 weight ppm, more preferably at least 10 weight ppm, even more preferably at least 30 weight ppm and particularly with 50 weight ppm of hydroquinone monoether, all based on the nonneutralized monomer a). For example, the monomer solution may be prepared using an ethylenically unsaturated acid-functional monomer comprising an appropriate level of hydroquinone monoether. This stabilizer is occasionally also referred to as “polymerization inhibitor” even though it is merely intended to inhibit an uncontrolled or premature polymerization and not the desired polymerization to form the superabsorbent.

Preferred hydroquinone monoethers are hydroquinone monomethyl ether (MEHQ) and/or alpha-tocopherol (vitamin E). These stabilizers require dissolved oxygen for optimum performance. Therefore, before polymerization, the monomer solution can be freed of dissolved oxygen by inertization, i.e., passing an inert gas, preferably nitrogen or carbon dioxide, through the monomer solution, and thereby the degree of stabilization of the monomer against polymerization is conveniently reduced. The level to which the oxygen content of the monomer solution is reduced before polymerization is preferably to less than 1 weight ppm, more preferably to less than 0.5 weight ppm and most preferably to less than 0.1 weight ppm.

Suitable crosslinkers b) are compounds having at least two groups suitable for crosslinking. Such groups are for example ethylenically unsaturated groups which can be free-radically polymerized into the polymer chain, and functional groups capable of forming covalent bonds with the acid groups of the monomer a). Useful crosslinkers b) further include polyvalent metal salts capable of forming coordinative bonds with at least two acid groups of monomer a).

Crosslinkers b) are preferably compounds having at least two polymerizable groups which can be free-radically polymerized into the polymer network. Suitable crosslinkers b) are for example ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 530 438 A1, di- and triacrylates as described in EP 547 847 A1, EP 559 476 A1, EP 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures as described for example in DE 195 43 368 A1, DE 196 46 484 A1, WO 90/15830 A1 and WO 2002/32962 A2.

Preferred crosslinkers b) are pentaerythritol triallyl ether, tetraalloxyethane, methylenebismethacrylamide, 15-tuply ethoxylated trimethylolpropane triacrylate, polyethylene glycol diacrylate, trimethylolpropane triacrylate and triallylamine.

Very particularly preferred crosslinkers b) are the diacrylated, dimethacrylated, triacrylated or trimethacrylated multiply ethoxylated and/or propoxylated glycerols as described for example in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred, especially the triacrylate of 3-tuply ethoxylated glycerol.

The amount of crosslinker b) is generally in the range from 0.05% to 1.5% by weight, more preferably in the range from 0.1% to 1% by weight and most preferably in the range from 0.3 to 0.6% by weight, all based on monomer a).

As initiators c) it is possible to use any compound which forms free radicals under the polymerization conditions, for example thermal initiators, redox initiators or photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Mixtures of thermal initiators and redox initiators are often used, such as sodium peroxodisulfate/hydrogen peroxide/ascorbic acid. As reducing component, however, it is preferable to use a mixture of the sodium salt of 2-hydroxy-2-sulfinatoacetic acid, the disodium salt of 2-hydroxy-2-sulfonatoacetic acid and sodium bisulfite. Such mixtures are available as Bruggolite® FF6 and Bruggolite® FF7 (Bruggemann Chemicals; Heilbronn; Germany). Superabsorbent nonwovens are often also produced by photopolymerization, in which case suitable photoinitiators are used. Preferred initiators include water-soluble azo compounds such as 2,2′-azobis(2-(2-imidazol-2-yl))propane dihydrochloride and 2,2′-azobis(amidino)propane dihydrochloride, water-soluble benzophenones such as 4-benzoyl-N,N,N-trimethylbenzenemethanaminium chloride, 2-hydroxy-3-(4-benzoylphenoxy)-3-N,N,N-trimethyl-1-propanaminium chloride monohydrate, 2-hydroxy-3-(3,4-dimethyl-9-oxo-9H-thioaxanthon-2-yloxy)-N,N,N-trimethyl-1-propanaminium chloride, 2-hydroxy-1-[4-(hydroxyethoxy)phenyl]-2-methyl-1-propanone, 2-hydroxy-2-methyl-1-phenylpropan-1-one and 4-benzoyl-N,N-dimethyl-N-[2-(1-oxo-2-propenyl)oxy]ethylbenzenemethanaminium chloride. A particularly preferred initiator combination comprises not only an azo initiator but also 2-hydroxy-1-[4-(hydroxethoxy)phenyl]-2-methyl-1-propanone.

The monomer solution or suspension comprises a sufficient amount of one or more initiators to fully polymerize the superabsorbent-forming monomer present in the monomer solution or suspension. The initiator quantity is typically in the range from 0.01% to 5.0% and preferably in the range from 0.2% to 2.0% by weight, based on the weight of monomer a).

Ethylenically unsaturated monomers d) copolymerizable with the ethylenically unsaturated acid-functional monomers a) are for example acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate.

As water-soluble polymers e) there can be used polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

The monomer solution typically comprises a solvent or suspension medium f). Since it is mostly solutions which are used or suspensions comprising relatively small proportions of insoluble components (supersaturated solutions for example), only solutions will for simplicity be referenced hereinbelow. Any solvent or solvent mixture can be used that provides a satisfactory application of the monomer solution to the nonwoven. Water is mostly and preferably used. The water content of the monomer solution is generally at least 40% by weight, preferably at least 45% by weight and more preferably at least 50% by weight and also generally at most 75% by weight, preferably at most 70% by weight and more preferably at most 65% by weight. When the monomer solution is applied to the nonwoven by spraying, the water quantity is adjusted such that a readily sprayable solution is obtained. Alternatively, this can also be achieved by using thickeners. The viscosity to which the spraying solution is set is generally at least 20 centipoise, preferably at least 30 centipoise and more preferably at least 40 centipoise and also generally at most 400 centipoise, preferably at most 150 centipoise and more preferably at most 100 centipoise, all measured in a Brookfield viscometer. An increasing water content means increasing energy requirements at the subsequent drying and a decreasing water content may mean inadequate removal of the heat of polymerization.

The monomer solution optionally comprises further additions or auxiliary materials. Examples of such additions or auxiliary materials are hygroscopic substances, in particular sodium chloride, as described for example in WO 2006/106096 A1 or JP 05/105705 A, plasticizers, as described in WO 2007/023085 A1, thickeners or thickening materials, for example finely divided particulate superabsorbents as described in WO 01/56625 A2.

The order in which the components of the monomer solution are added to prepare the monomer solution is not particularly important as such, but for safety reasons it is preferable to add the initiator last.

A sheet material of the present invention is produced by initially applying the monomer solution to the foam used as backing or substrate material. Convenient methods of application involve spraying or dipping the monomer solution on to the foam or saturating the foam with monomer solution, conveniently by passing a length of foam sheeting or a cut-to-size piece of foam through the monomer solution in a pad-mangle or comparable apparatus whereby the application of predetermined amounts of liquid to a sheetlike structure is possible.

The monomer solution is typically applied in such amounts that the content obtained of ready-produced superabsorbent after final drying is generally at least 20 g/m², preferably at least 40 g/m² and more preferably at least 40 g/m² and also generally at most 700 g/m², preferably at most 500 g/m² and more preferably at most 400 g/m².

The monomer solution is preferably applied by spraying. Spraying can take place by means of any customary spraying device, for example through nozzles. Not only one-material nozzles but also two-material nozzles in which the monomer solution is nebulized by gas can be used. The gas used can be air or an inert gas such as nitrogen, argon or helium. Preference is given to use of air, nitrogen or of a nitrogen-air mixture. The use of an inert gas such as nitrogen has the advantage of promoting the removal of oxygen from the monomer solution and of thereby reducing the polymerization-inhibiting effect of stabilizers such as MEHQ.

After the monomer solution has been applied to the foam, the foam is subjected to conditions at which the monomers polymerize. Depending on the initiator in the monomer solution, these conditions comprise for example the action of heat, ultraviolet rays, electron beam rays or their combination on the foam with the applied monomer solution. The polymerization can be carried out batchwise or continuously, for example by passing the foam with the applied monomer solution through irradiation or heating sectors on a conveyor belt.

When the polymerization is initiated thermally, the reaction apparatus is not subjected to any special limitations. In the case of batch polymerizations, the monomer solution applied to the foam can be polymerized in an oven in air or an inert atmosphere or else in vacuo. In the case of a continuous polymerization, the foam passes through a dryer, for example an infrared dryer, a through-air dryer or the like. The polymerization temperature is chosen as a function of the thickness of the foam, the monomer concentration and the identity and amount of the thermal initiator used in the monomer solution such that complete polymerization is obtained apart from the residual monomer concentration tolerable in an individual case. Thermal polymerization temperature is typically in the temperature range from 20° C. to 150° C. and preferably from 40° C. to 100° C. The polymerization time depends on the polymerization temperature, but is typically in the range from a few seconds to 2 hours and preferably in the range from a few seconds to 10 minutes.

When the polymerization is initiated by means of ultraviolet radiation, conventional UV lamps are typically used. The irradiation conditions, such as the irradiation intensity and time, depend on the type of foam used, on the amount of monomer applied to the foam and on the initiator quantity and type, and are chosen as customary in the art. Irradiation is typically carried out using a UV lamp having an intensity in the range from 100 to 700 watts per inch, preferably in the range from 400 to 600 watts per inch, at a distance between 2 to 30 centimeters between UV lamp and foam, for a period ranging from 0.1 seconds to 10 minutes. Irradiation with ultraviolet rays can take place in vacuo, in the presence of an inert gas, such as nitrogen, argon, helium or the like, or in air. Irradiation temperature is not critical in that the irradiation of the sprayed foam can mostly be carried out at room temperature with satisfactory results.

Polymerization initiation by means of electron beams can be accomplished using for example a commercially available electron beam accelerator such as the Electrocurtain® C B 175 (Energy Sciences, Inc., Wilmington, Mass.). Accelerators operating in the 150 to 300 kilovolt range are acceptable. The beam current of such systems, typically in the range from 1 to 10 milliamperes, can be adjusted to obtain the desired dose of ionizing radiation. The ionizing radiation dose employed will vary somewhat, depending on factors such as the presence or absence of crosslinking monomers, the desired degree of polymerization for the polymer, the degree of crosslinking desired and the like. In general, it is desirable to irradiate the foam with the applied monomer solution with doses from about 1 to 16 megarads and preferably 2 to 8 megarads. Particularly when using lower doses is it desirable to purge oxygen from the monomer solution, for example by bubbling nitrogen through the solution before applying it to the foam. The dose is preferably so chosen that no fiber degradation occurs.

After polymerization, the sheet material is customarily dried, for example by drying in a forced air oven, passing through a forced air dryer, passing through a sector illuminated by infrared lamps, or other suitable and known measures and apparatus for drying sheeting. Drying is continued until the desired moisture content is achieved for the superabsorbent.

The foam used as backing or substrate material can be coated on one side or on both sides with monomer solution to be polymerized and thereby be provided with superabsorbent on one side or on both sides.

If desired, the sheet material can be aftertreated. Examples of possible aftertreatments are the application of plasticizers, softeners, surfactants, other textile auxiliaries, the setting of a desired moisture content or the surface postcrosslinking (often also only “postcrosslinking”) of the superabsorbent particles. These measures can also be combined. Additives are applied in a conventional manner, for instance by dipping the sheet material into the additive, provided the latter is liquid, or a solution thereof and squeezing off excess liquid in a pad-mangle, spraying with a liquid or dissolved additive, soft brush or sponge application and subsequent drying in a conventional manner.

Suitable surface postcrosslinkers are compounds comprising groups capable of forming covalent bonds with two or more carboxylate groups on the polymer particles. Suitable compounds are for example polyfunctional amines, polyfunctional amidoamines, polyfunctional epoxides as described in EP 83 022 A2, EP 543 303 A1 and EP 937 736 A2, di- or polyfunctional alcohols as described in DE 33 14 019 A1, DE 35 23 617 A1 and EP 450 922 A2, or β-hydroxyalkylamides as described in DE 102 04 938 A1 and U.S. Pat. No. 6,239,230. Furthermore, DE 40 20 780 C1 describes cyclic carbonates, DE 198 07 502 A1 2-oxazolidone and its derivatives, such as 2-hydroxy-ethyl-2-oxazolidone, DE 198 07 992 C1 bis- and poly-2-oxazolidinones, DE 198 54 573 A1 2-oxotetrahydro-1 ,3-oxazine and its derivatives, DE 198 54 574 A1 N-acyl-2-oxazolidones, DE 102 04 937 A1 cyclic ureas, DE 103 34 584 A1 bicyclic amide acetals, EP 1 199 327 A2 oxetans and cyclic ureas and WO 2003/31482 A1 morpholine-2,3-dione and its derivatives as suitable postcrosslinkers. Preferred postcrosslinkers are ethylene carbonate, ethylene glycol diglycidyl ether, reaction products of polyamides with epichlorohydrin and mixtures of propylene glycol and 1,4-butanediol. Very particular preferred postcrosslinkers are 2-hydroxyethyloxazolidin-2-one, oxazolidin-2-one and 1,3-propanediol. It is further possible to use postcrosslinkers which comprise additional polymerizable ethylenically unsaturated groups, as described in DE 37 13 601 A1.

When postcrosslinking is carried out, the amount of postcrosslinker will generally be in the range from 0.001% to 2% by weight, preferably in the range from 0.02% to 1% by weight and more preferably in the range from 0.05% to 0.2% by weight, all based on the amount of superabsorbent in the nonwoven.

In one further embodiment of the present invention, polyvalent cations are applied to the particle surface in addition to the postcrosslinkers, or as postcrosslinkers, before, during or after postcrosslinking. Useful polyvalent cations for the process of the present invention include for example bivalent cations, such as the cations of zinc, magnesium, calcium, iron and strontium, tervalent cations, such as the cations of aluminum, iron, chromium, rare earths and manganese, quadrivalent cations, such as the cations of titanium and zirconium. Useful counterions include chloride, bromide, sulfate, hydrogensulfate, carbonate, bicarbonate, nitrate, phosphate, hydrogenphosphate, dihydrophosphate, and carboxylate, such as acetate and lactate. Aluminum sulfate is preferred. Polyamines can also be used as polyvalent cations as well as metal salts.

The amount of polyvalent cation used is for example in the range from 0.001% to 1.5% by weight, preferably in the range from 0.005% to 1% by weight and more preferably in the range from 0.02% to 0.8% by weight, all based on the polymer particles.

Postcrosslinking is typically carried out by spraying a solution of the postcrosslinker onto the dried sheet material. Drying is carried out after spraying, and the postcrosslinking reaction can take place not only before but also during drying. Spraying (application by impregnation is also possible in principle) and drying are carried out as described above for the polymerization of the monomer solution.

The postcrosslinkers are typically used in the form of an aqueous solution. The depth of penetration of the postcrosslinker into the superabsorbent particles can be controlled via the level of nonaqueous solvent or overall solvent quantity. When water is exclusively used as solvent, it is advantageous to add a surfactant. This improves wetting and reduces clumping. Preferably, however, solvent mixtures are used, for example isopropanol-water, 1,3-propanediol-water and propylene glycol-water, the weight mixing ratio preferably being in the range from 20:80 to 40:60.

The sheet material of the present invention may optionally be laminated with one or more further layers of textiles or non-textiles to form moisture-regulating composites or composite textiles. Examples of such further layers are foams, pads, nonwovens, wovens, knits, artificial leather or other sheetlike plastics materials. Materials for such further layers are known and are selected according to the intended purpose. Lamination is done in a conventional manner. The desired material bond is produced for example by adhering areally or with an adhesive mesh, or by melting, welding (for example thermally or ultrasonically) of fibers. However, it is also possible to laminate the textile layers by stitching or quilting.

“Composite” refers to a multi-ply textile sheet material. Composites are usually two- or three-ply, but may also have further plies depending on intended use or desired properties. Economically, it is always desirable to produce a composite having the desired properties from as few plies as possible. Such composites are used for example as covers for seat furniture or mattresses, as seat cover, roof liner, foot mats or interior trim in motor vehicles or as other textile surfaces.

One ply of the composite is formed by an outer material which, at the use site of the composite, forms the composite's external surface, which faces the observer or user, and at least one further ply of the composite is formed by a sheet material of the present invention. It is the sheet material of the present invention which endows the composite with moisture-regulating properties.

The present invention sheet materials and composites are very useful for moisture regulation, especially in mattresses and seat pads, for example in seat furniture or automotive seats, and also in other interior trim or foot mats. It was determined more particularly that the present invention sheet materials and composites have good wet-stability. Therefore they are also suitable for use in a permanently moist environment, for example as primary wound dressings. They are also particularly washable and suitable for use in textiles such as safety and functional apparel or else in sponge or wipe cloths.

Seat pads or mattresses comprising the present invention sheet materials or composites provide enhanced sitting or lying comfort since the sheet material in the composite regulates the relative atmospheric humidity to a pleasant degree and prevents excessive sweating. At the same time, the composites of the present invention are capable of optimally releasing the imbibed moisture again in phases of non-use and of rapidly regenerating themselves.

1. A sheet material comprising an open-cell foam and a superabsorbent and being not more than 30 mm in thickness.

2. The sheet material according to claim 1 being not more than 15 mm in thickness.

3. The sheet material according to claim 2 being not more than 5 mm in thickness.

4. The sheet material according to claim 1 wherein the foam is a polyurethane, polyester, synthetic, or natural latex foam.

5. The sheet material according to claim 1 wherein the superabsorbent is a crosslinked polymer based on partially neutralized acrylic acid.

6. A process for producing a sheet material as defined in claim 1, comprising the steps of
i) providing a foam,
ii) applying to the foam a mixture comprising at least one ethylenically unsaturated monomer bearing at least one acid group, and
iii) polymerizing the mixture to form the superabsorbent.

7. The process according to claim 6 wherein the ethylenically unsaturated monomer bearing at least one acid group is partially neutralized acrylic acid.

8. The process according to claim 7 wherein the acrylic acid is at least 25 mol % neutralized.

9. (canceled)

10. A composite material comprising at least one sheet material according to claim 1.

11. A method of regulating moisture in an article comprising incorporating a sheet material of claim 1 into the article.
